(19) United States
(12) Patent Application Publication
(10) Pub. No.: US 2011/0200809 A1
(43) Pub. Date: Aug. 18, 2011

(54) SULFITE SOFTWOOD BASED CELLULOSE TRIACETATE FOR LCD FILMS

(75) Inventors: Darryl Aubrey Godfrey, Gray, TN (US); Laurel Leigh Reitfort, Kingsport, TN (US)

(73) Assignee: Eastman Chemical Company, Kingsport, TN (US)

(21) Appl. No.: 13/008,253

(22) Filed: Jan. 18, 2011

Related U.S. Application Data
(60) Provisional application No. 61/303,810, filed on Feb. 12, 2010.

(51) Int. Cl. C09D 101/12; B29C 47/14; B32B 5/00

(52) U.S. Cl. 428/220; 264/207; 106/171.1; 106/170.13; 106/170.26; 106/170.53

(57) ABSTRACT

The invention provides a way of using cellulose triacetate (CTA) made from softwood pulp to make films suitable for use in liquid crystal displays (LCDs). It has been surprisingly found that a combination of certain additives in the film casting dope and of metal and sulfur content of the CTA allow a softwood CTA to exhibit peeling characteristics from the casting substrate that are similar to those of lint-based CTA of similar sulfur content. The additives include a combination of acid scavengers and chelating agents.

### CROSS REFERENCES TO RELATED APPLICATIONS

This application claims the benefit of U.S. Provisional Application Ser. No. 61/303,810 filed Feb. 12, 2010.

### FIELD OF THE INVENTION

The present invention generally relates to using cellulose triacetate (CTA) made from sulfite-process softwood pulp to make films suitable for use in liquid crystal displays (LCDs). More particularly, the present invention relates to a dope for making a solvent-cast film containing the CTA, a method of preparing the dope, a film containing the CTA, a method of making a film containing the CTA, a polarizer plate for an LCD containing the film, and an optical lens containing the film.

### BACKGROUND OF THE INVENTION

Cellulose triacetate (CTA) is used in solvent-cast liquid crystal display (LCD) films for flat panel displays. CTA may be made from cotton linters (lint), hardwood, or softwood cellulose. Initially, only lint CTA was used for these applications, because it could be peeled more easily from the stainless steel casting substrate.

As the LCD film market grew, the price of high-quality lint cellulose used to make CTA increased substantially relative to the price of hardwood and softwood pulps. LCD film growth was projected to exceed lint cellulose supply, so in 2004 a major LCD film caster implemented co-casting dies that allowed a core of hardwood CTA with thin outer layers of lint CTA to be cast. Other LCD film casters currently use only lint CTA in LCD films ranging from 22 to 80 microns thick.

Thus, there is a continuing need in the art for LCD films to be made from cheaper sources of CTA such as from softwood pulp. The present invention is directed to addressing this need as well as others that will become apparent from the following description and claims.

### SUMMARY OF THE INVENTION

It has been surprisingly discovered that a combination of additives in the film casting dope plus control of metal and sulfur content of the CTA allow a softwood CTA having low sulfur content to exhibit peeling characteristics from the casting substrate that are similar to those of lint-based CTA of similar sulfur content. Additionally, it has been surprisingly discovered that the softwood CTA casting dope can provide a film with less haze, greater toughness, and comparable color to a film made from lint-based CTA. This film caster has recently extended this technology to allow films to be made using 90% hardwood CTA and 10% lint CTA and to use 100% hardwood CTA with the certain additives and film casting technology.

Thus, in one aspect, the present invention provides a dope for making a solvent-cast film. The dope comprises:
(a) cellulose triacetate made from sulfite-process softwood pulp and having less than 35 ppm of sulfur and less than 1 weight percent of xylose, both based on the weight of the cellulose triacetate, and a molar ratio of metals to sulfate of at least 3:1;
(b) an acid scavenger;
(c) a chelating agent; and
(d) a solvent.

Thus, in one aspect, the present invention provides a dope for making a solvent-cast film. The dope comprises:
(a) cellulose triacetate made from sulfite-process softwood pulp and having less than 35 ppm of sulfur and less than 2 weight percent of xylose, both based on the weight of the cellulose triacetate, and a molar ratio of metals to sulfate of at least 3:1;
(b) an acid scavenger;
(c) a chelating agent; and
(d) a solvent.

In another aspect, the present invention provides a method of preparing the dope. The method comprises:
(a) combining the cellulose triacetate, the acid scavenger, and the solvent together to form a solution; and
(b) adding the chelating agent to the solution from step (a) to form the dope.

In another aspect, the present invention provides a film comprising:
(a) cellulose triacetate made from sulfite-process softwood pulp and having less than 35 ppm of sulfur and less than 1 weight percent of xylose, both based on the weight of the cellulose triacetate, and a molar ratio of metals to sulfate of at least 3:1;
(b) an acid scavenger; and
(c) a chelating agent.

In another aspect, the present invention provides a film comprising:
(a) cellulose triacetate made from sulfite-process softwood pulp and having less than 35 ppm of sulfur and less than 2 weight percent of xylose, both based on the weight of the cellulose triacetate, and a molar ratio of metals to sulfate of at least 3:1;
(b) an acid scavenger; and
(c) a chelating agent.

In another aspect, the present invention provides a method of making a film. The method comprises:
(a) casting the dope according to the invention onto a continuously moving support to form a cast film on the support;
(b) partially drying the cast film;
(c) separating the cast film from the support; and
(d) drying the separated film.

In another aspect, the present invention provides a polarizer plate for a liquid crystal display, wherein the polarizer plate comprises films according to the invention.

In another aspect, the present invention provides an optical lens comprising films according to the invention.

### DETAILED DESCRIPTION OF THE INVENTION

The dope for making a solvent-cast film according to the invention comprises four main components. The first main component is a cellulose triacetate made from sulfite-process softwood pulp and having less than 35 ppm of sulfur and less than 1 weight percent of xylose, both based on the weight of the cellulose triacetate, and a molar ratio of metals to sulfate of at least 3:1. Alternatively, the first main component is a cellulose triacetate made from sulfite-process softwood pulp and having less than 35 ppm of sulfur and less than 2 weight percent of xylose, both based on the weight of the cellulose triacetate, and a molar ratio of metals to sulfate of at least 3:1.

By “sulfite-process softwood pulp,” it is meant wood pulp made from softwood trees such as spruce, pine, fir, larch, hemlock, and the like, using the sulfite process. The sulfite process produces wood pulp that is almost pure cellulose fibers by using various salts of sulfurous acid to extract the lignin from softwood chips in large pressurized vessels. The salts used are either sulfites or bisulfites, and the counter ions are typically sodium, calcium, potassium, or magnesium. The cellulose fibers are subsequently acetylated to yield cellulose triacetate (CTA).

Without wishing to be bound by theory, it is believed that sulfite-process cellulose has branched xylan chains, which when acetylated, are more soluble in the film casting solvent than are the linear xylan chains of prehydrolyzed kraft (PHK) cellulose-based CTA.

In another embodiment, the CTA has less than 25 ppm of sulfur. In another embodiment, the CTA has 8 to 15 ppm of sulfur.

In another embodiment, the CTA has 0.8 weight percent or less of xylose. In another embodiment, the CTA has 0.5 to 0.6 weight percent of xylose. In other embodiments, the CTA may have a xylose content up to 1.5 or 2 weight percent. In other embodiments, the CTA may have a xylose content from 0.5 to 1.5 or from 0.5 to 2 weight percent. In other embodiments, the CTA may have a xylose content 0.5 to 0.8 weight percent. In these embodiments, the CTA may also have a mannose content ranging from 0.5 to 1.5 weight percent or from 0.5 to 1.2 weight percent or from 0 to 1.5 weight percent.

In another embodiment, the CTA has at least 98 weight percent of a-cellulose, which is generally made from a high-purity grade cellulose. In another embodiment, the CTA has at least 96 weight percent of a-cellulose, which is generally made from a high-purity grade cellulose.

In another embodiment, the CTA has a molar ratio of metals to sulfate ranging from 3:1 to 5:1, or 3:1 to 11:1, or 3:1 to 16:1. The metals, as noted above, typically include sodium, calcium, potassium, and/or magnesium, and can be in ionic form or bound as a salt.

The CTA for use in the present invention can have any combination of sulfur content, xylose content, a-cellulose content, and molar ratio of metals to sulfate mentioned herein. The CTA having the properties described herein is commercially available from Eastman Chemical Company and may be made according to the process described in U.S. Pat. No. 6,924,010; the entire content of which is hereby incorporated by reference.

The CTA is usually present in the dope in an amount ranging from 15 to 23 weight percent, based on the weight of the dope.

The second main component of the dope according to the present invention is an acid scavenger such as epoxidized soybean oil (ESO) (CAS No. 8013-07-8). ESO is commercially available from various manufacturers such as from Chemtura Corporation under the name Drapex® 6.8. Epoxidized plant oils (EPO) which can be represented and exemplified by compositions of various epoxidized long chain fatty acid triglycerides (for example, epoxidized soybean oil and epoxidized linseed oil and other unsaturated natural oils (these are occasionally called epoxidized natural glycerides or unsaturated fatty acid and these fatty acid have 12-22 carbon atoms). These acid scavengers may be used in all embodiments of the dope and/or film of the present invention.

Without wishing to be bound by theory, it is believed that the acid scavenger reacts with free acetic acid in the CTA to prevent the acid from causing odor, discoloration, and further hydrolysis of the CTA, which would change the optical and physical properties of the resulting film.

The acid scavenger is typically present in the dope in an amount ranging from 0.1 to 1 weight percent, based on the total weight of the dope.

The third main component of the dope according to the present invention is a chelating agent such as citric acid. The chelating agent is usually present in the dope in an amount ranging from 0.01 to 0.1 weight percent, based on the total weight of the dope. Other non-limiting examples of chelating agents include, but are not limited to, tartaric acid, oxalic acid, alkali metal (Group I of the Period Table) salts of the acids, alkaline earth metal (Group II of the Periodic Table) salts of the acids, or mixtures thereof. These chelating agents may be used in all embodiments of the dope and/or film of the present invention.

Without wishing to be bound by theory, it is believed that the chelating agent complexes with the poorly soluble metal sulfate salts remaining in the CTA to inhibit their further precipitation onto the casting substrate.

The fourth main component of the dope according to the invention is a solvent. The typical solvent for a casting dope includes methylene chloride and from 6 to 20 weight percent of methanol, ethanol, or both, based on the weight of the solvent. More typically, the solvent would be a 90/10 weight mixture of methylene chloride and methanol or ethanol.

The dope usually contains from 65 to 75 weight percent of the solvent.

The dope according to the invention may contain additional additives such as anti-solvents (e.g., n-butanol or isopropanol), hindered amine light stabilizers (HALS), dyes, plasticizers, UV-absorbers, flame retardants, matting agents, etc.

The dope according to the invention can be prepared by first blending the CTA and the acid scavenger with the solvent in a suitable mixing device, such as a stirred container, to form a solution. The chelating agent is then added to the solution to form the dope.

The dope according to the invention can be used to form solvent cast films using techniques known in the art. For example, the dope can be cast either by gravity or pressure onto a support such as a rotating belt or drum to form a cast film on the support. After casting, the cast film is partially dried to leave a residual solvent content of, for example, 12 to 17 weight percent or from 12 to 30 weight percent. The partially dried cast film is then separated from the support such as by a peeling roll. The separated film then undergoes additional drying to form the final film.

The film according to the present invention comprises the CTA, acid scavenger, and chelating agent as its main components. In particular, the resulting film typically contains from 80 to 95 weight percent of the CTA, from 1 to 5 weight percent of the acid scavenger, and 0.1 to 0.5 weight percent of the chelating agent. The film may contain up to 10 weight percent of other additives.

The film according to the invention can vary in thickness, depending on the end-use application. For example, the film can have a thickness ranging from 20 to 100 microns. Particularly preferred are films having a thickness in the range of 40 to 80 microns for use in LCDs.

The film according to the invention is suitable for use in various applications, such as in a polarizer plate for an LCD. A polarizer plate in an LCD has a polarizer protective film attached to at least one side of a polarizer. Typically, a polarizer is obtained by dyeing a stretched polyvinyl alcohol (PVA) film with iodine or a dichroic dye. In most cases, a CTA film is used as the protective film for the PVA film and can be attached directly to it. The surface of the CTA film may be saponified with an alkaline solution to enhance adhesion in the polarizer assembly.

The film according to the invention can also be used as a component of an optical lens, such as in a camera, telescope, or eyeglasses including sunglasses and 3-D glasses. The film may also be used in combination with a polarizer, as discussed above, in the lens of optical microscopes and sunglasses.

This invention can be further illustrated by the following examples of preferred embodiments thereof, although it will be understood that these examples are included merely for purposes of illustration and are not intended to limit the scope of the invention.

### EXAMPLES

### Testing Methodology

The intrinsic viscosity (IV) of the CTA was determined according to ASTM method D 871-91, “Standard Test Methods of Testing Cellulose Acetate” using a Viscotek Y501V viscometer. Intrinsic viscosity is defined to be the limit of the natural logarithm of the relative viscosity to the concentration as the concentration goes to zero. The solvent used was N-methylpyrrolidone. ASTM D 1343-91 was used to determine the viscosity of the CTA.

ASTM D 882 was used to determine break strain, break stress, yield strain, yield stress, and Young's modulus of the film.

ASTM D 1003 was used to determine film haze and transmittance.

ASTM E 1164 was used to obtain spectrophotometric data for color evaluations, and ASTM E 308 was for color computation using the CIE system.

For Examples 1-24, film thickness retardation (Rth) and planar retardation (Re) were determined using a Woollam ellipsometer. For Examples 25-28, Rth was determined using a COBRA-WR instrument.

Qualitative Peel Strength Test—A screening test was used in which films were peeled by hand and assigned a qualitative rating of 1 to 3, with 1 reflecting easy peel with no sticking, 2 being moderate peel force needed but no residue remaining on the plate, and 3 representing strong force to peel, tearing of the film, or a residue left on the plate.

Quantitative Peel Strength Test—In order to measure the peeling force of various films more precisely, an Instron tensile tester was employed. Actual film casting belt material from the manufacturer of commercial casting belts was obtained and used as the substrate for the peeling force testing. The films were cast to achieve a final thickness of 60 microns. They were cast 2 inches (5.08 cm) in width and approximately 10 inches (25.4 cm) in length. The metal plate was mounted horizontally in the Instron tensile tester and the film was pulled vertically. The plate was mounted on a sled allowing for it to move laterally to maintain a constant 90° angle during the measurement. The force required to peel the film from the plate was measured by a load cell as the film peeled at a rate of 100 inches/minute. This force was measured along the entire length of the plate. The peel strength was reported as the average force (grams) over the length of the film.

### Laboratory Film Casting Device

A laboratory film casting device was designed and constructed in order to prevent scratching of the mirror surface of the substrate, give a uniform width and length sample for testing, and reduce film thickness variation.

The laboratory film casting apparatus had a metal support with Teflon guide bars attached. Four toggle clamps were used to secure a 5-inch wide by 10-inch long piece of stainless steel film casting belt. The Teflon guide bars were spaced to allow a 2-inch wide drawdown knife to move the length of the metal plate. The drawdown knife has adjustment knobs that can change the gap between the blade and the metal plate to allow casting of different thickness films.

### Materials

The cellulose triacetates, VM114 and VM149, are commercially available from Eastman Chemical Company and were made according to the procedures described in U.S. Pat. No. 6,924,010. VM114 was made of sulfite-process softwood pulp, and VM149 was made from cotton linters. The average properties of VM114 and VM149 are reported in Table 1.

TABLE 1

| | VM114 | VM 149 |
|---|---|---|
| Wt % Xylose | 0.48 | 0.08 |
| Wt % Mannose | 0.58 | 0.08 |
| Cellulose Type | sulfite-process softwood pulp | cotton linters |
| Molecular Wt. Distribution | | |
| Mn | 79,170 | 82,807 |
| Mw | 282,358 | 278,055 |
| Mz | 727,540 | 703,604 |
| Polydispersity | 3.57 | 3.39 |
| IV (dL/g) | 2.32 | 2.40 |
| Viscosity (sec) | 71.8 | 45.9 |
| Wt % Acetyl | 43.58 | 43.51 |
| Color | 69 | 33 |
| Haze (%) | 5.4 | 4.0 |
| Elemental Analysis (ppm) | | |
| sulfur | 13 | 9 |
| magnesium | 52 | 2 |
| iron | 1 | 1 |
| calcium | 5 | 33 |
| sodium | 5 | 2 |
| potassium | 3 | 1 |
| total metals | 66 | 39 |

The chelating agent used was citric acid.

The epoxidized soybean oil used was Drapex 6.8.

Triphenyl phosphate and carboxymethyl ethylphthalate were used as plasticizers.

Tinuvin 328 and Neo Heliopan 357 were used as typical UV inhibitors in the pressure casting trial (Examples 25-28).

Methanol, methylene chloride, and n-butanol were used as the solvents in the statistically designed experiments (Examples 1-24), but only methanol and methylene chloride were used in the pressure casting trial.

### Examples 1-24

### Dope Preparation

The CTA samples (VM114) were dried in a forced draft oven for 2 hours at 105° C., and then they were placed into a desiccator to cool. The solvents and additives were weighed and mixed in round bottles. The CTA was added slowly to the solvent in order to wet the individual particles and to reduce clumping. The bottle containing this mixture was placed into a paint shaker for 18 minutes. After this, the bottles were moved to a mechanical roller overnight to complete dissolution of the CTA. The bottles were removed from the roller and allowed to stand until the bubbles in the solutions dissipated.

### Film Preparation

60-micron thick films were hand cast on the laboratory film casting device and dried to 10-12 wt % residual solvent content. This level was chosen to simulate the low end of the 10 wt %-30 wt % typical residual solvent content range encountered when commercial LCD films are peeled from the casting belt. Experience has shown that the higher the residual solvent content, the less force that is needed to peel the film. However, if solvent content is too high, the films will distort when peeled and be useless.

To cast the films, the solution was poured onto one end of the metal plate, then the drawdown blade was quickly pulled the length of the plate. The plate was then removed from the casting apparatus and placed into a film curing cabinet that was located inside a fume hood. The cabinet allowed evaporation of the solvents at a controlled rate. The necessary time to reach the 10-12 wt % residual solvent was determined by measuring the solvent content of films at 10 minute intervals of curing time in the cabinet. This time was determined to be approximately 1 hour. The curing time is well understood to be dependent on relative humidity, which must be monitored, because higher humidity retards solvent evaporation.

The composition of each dope and film, and the film's properties are reported in Table 2.

TABLE 2

| | EXAMPLE | | | | | |
|---|---|---|---|---|---|---|
| | 1 | 2 | 3 | 4 | 5 | 6 |
| Wt % in Dope | | | | | | |
| VM114 | 15.00% | 15.00% | 15.00% | 15.00% | 15.00% | 15.00% |
| Citric acid | 0.375% | 0.250% | 0.500% | 0.500% | 0.300% | 0.250% |
| Drapex.6.8 | 0.75% | 0.50% | 1.00% | 0.00% | 0.70% | 0.00% |
| Triphenyl | 1.00% | 1.00% | 1.00% | 1.00% | 1.00% | 1.00% |
| Phosphate | | | | | | |
| Carboxymethyl | 0.34% | 0.34% | 0.34% | 0.34% | 0.34% | 0.34% |
| ethylphthalate | | | | | | |
| Methanol | 6.00% | 7.54% | 5.22% | 5.32% | 8.27% | 6.84% |
| Methylene chloride | 74.28% | 74.62% | 73.94% | 74.84% | 74.39% | 75.07% |
| n-butanol | 2.25% | 0.750% | 3.000% | 3.00% | 0.00% | 1.50% |
| TOTAL | 100.00% | 100.00% | 100.00% | 100.00% | 100.00% | 100.00% |
| Wt % in Film | | | | | | |
| VM114 | 85.89% | 87.77% | 84.08% | 89.07% | 86.51% | 90.42% |
| Citric acid | 2.15% | 1.46% | 2.80% | 2.97% | 1.73% | 1.51% |
| Drapex.6.8 | 4.29% | 2.93% | 5.61% | 0.00% | 4.04% | 0.00% |
| Triphenyl | 5.73% | 5.85% | 5.61% | 5.94% | 5.77% | 6.03% |
| Phosphate | | | | | | |
| Carboxymethyl | 1.95% | 1.99% | 1.91% | 2.02% | 1.96% | 2.05% |
| ethylphthalate | | | | | | |
| TOTAL | 100.00% | 100.00% | 100.00% | 100.00% | 100.00% | 100.00% |
| Film Properties | | | | | | |
| Break Strain (%) | 18.5 | 19.7 | 25.22 | 26.46 | 10.42 | 23.18 |
| Break Stress (psi) | 12,639 | 13,162 | 13,222 | 14,255 | 12,444 | 15,019 |
| Thickness | 62.1 | 64.0 | 66.9 | 65.1 | 85.7 | 59.4 |
| (microns) | | | | | | |
| Yield Strain (%) | 4.54 | 4.14 | 4.2 | 4.12 | 4.48 | 4.26 |
| Yield Stress (psi) | 11,231 | 11,294 | 10,805 | 11,086 | 12,516 | 11,882 |
| Young's Modulus | 440,826 | 465,398 | 429,309 | 443,258 | 480,146 | 483,053 |
| (psi) | | | | | | |
| Re @ 589 nm, | 0.0 | 0.0 | 0.1 | 0.0 | 0.2 | 0.2 |
| normalized to 60 | | | | | | |
| micron | | | | | | |
| Rth @ 589 nm, | −33.6 | −25.6 | −14.9 | −23.2 | −31.4 | −35.9 |
| normalized to 60 | | | | | | |
| micron | | | | | | |
| Haze (%) | 0.37 | 0.12 | 0.34 | 0.14 | 0.14 | 0.11 |
| Total Transmittance | 92.76 | 92.82 | 92.81 | 92.85 | 92.84 | 92.82 |
| (%) | | | | | | |
| Peeling Strength | 1 | 1 | 1 | 2 | 1 | 2 |
| Rating | | | | | | |
| | EXAMPLE | | | | | |
| | 7 | 8 | 9 | 10 | 11 | 12 |
| Wt % in Dope | | | | | | |
| VM114 | 15.00% | 15.00% | 15.00% | 15.00% | 15.00% | 15.00% |
| Citric acid | 0.500% | 0.500% | 0.500% | 0.000% | 0.500% | 0.125% |
| Drapex.6.8 | 0.00% | 1.00% | 0.00% | 0.00% | 0.50% | 0.25% |
| Triphenyl | 1.00% | 1.00% | 1.00% | 1.00% | 1.00% | 1.00% |
| Phosphate | | | | | | |
| Carboxymethyl | 0.34% | 0.34% | 0.34% | 0.34% | 0.34% | 0.34% |
| ethylphthalate | | | | | | |
| Methanol | 5.32% | 8.22% | 8.32% | 8.37% | 6.77% | 6.08% |
| Methylene chloride | 74.84% | 73.94% | 74.84% | 75.29% | 74.39% | 74.96% |
| n-butanol | 3.00% | 0.00% | 0.00% | 0.00% | 1.50% | 2.25% |
| TOTAL | 100.00% | 100.00% | 100.00% | 100.00% | 100.00% | 100.00% |
| Wt % in Film | | | | | | |
| VM114 | 89.07% | 84.08% | 89.07% | 91.80% | 86.51% | 89.74% |
| Citric acid | 2.97% | 2.80% | 2.97% | 0.00% | 2.88% | 0.75% |
| Drapex.6.8 | 0.00% | 5.61% | 0.00% | 0.00% | 2.88% | 1.50% |
| Triphenyl | 5.94% | 5.61% | 5.94% | 6.12% | 5.77% | 5.98% |
| Phosphate | | | | | | |
| Carboxymethyl | 2.02% | 1.91% | 2.02% | 2.08% | 1.96% | 2.03% |
| ethylphthalate | | | | | | |
| TOTAL | 100.00% | 100.00% | 100.00% | 100.00% | 100.00% | 100.00% |
| Film Properties | | | | | | |
| Break Strain (%) | 22.78 | 28.18 | 22.28 | 19.7 | 24.44 | 26.62 |
| Break Stress (psi) | 14,167 | 15,147 | 15,364 | 14,660 | 13,584 | 15,208 |
| Thickness | 63.3 | 60.8 | 55.1 | 80.9 | 65.1 | 63.3 |
| (microns) | | | | | | |
| Yield Strain (%) | 4.36 | 4.32 | 4.14 | 4.8 | 4.42 | 4.22 |
| Yield Stress (psi) | 11,366 | 11,310 | 12,310 | 12,347 | 10,512 | 11,498 |
| Young's Modulus | 459,301 | 447,264 | 499,629 | 472,820 | 416,145 | 470,951 |
| (psi) | | | | | | |
| Re @ 589 nm, | 0.2 | 0.1 | 0.1 | 0.1 | 0.1 | −0.1 |
| normalized to 60 | | | | | | |
| micron | | | | | | |
| Rth @ 589 nm, | −28.7 | −36.0 | −46.9 | −56.3 | −26.4 | −32.9 |
| normalized to 60 | | | | | | |
| micron | | | | | | |
| Haze (%) | 0.25 | 0.1 | 0.11 | 0.18 | 0.16 | 0.15 |
| Total Transmittance | 92.79 | 92.78 | 92.74 | 92.72 | 92.67 | 92.87 |
| (%) | | | | | | |
| Peeling Strength | 2 | 1 | 2 | 3 | 1 | 1 |
| Rating | | | | | | |

| | EXAMPLE | | | | | |
|---|---|---|---|---|---|---|
| | 13 | 14 | 15 | 16 | 17 | 18 |
| Wt % in Dope | | | | | | |
| VM114 | 15.00% | 15.00% | 15.00% | 15.00% | 15.00% | 15.00% |
| Citric acid | 0.00% | 0.50% | 0.00% | 0.00% | 0.00% | 0.00% |
| Drapex.6.8 | 0.50% | 0.000% | 1.000% | 0.00% | 1.00% | 0.00% |
| Triphenyl | 1.00% | 1.00% | 1.00% | 1.00% | 1.00% | 1.00% |
| Phosphate | | | | | | |
| Carboxymethyl | 0.34% | 0.34% | 0.34% | 0.34% | 0.34% | 0.34% |
| ethylphthalate | | | | | | |
| Methanol | 5.32% | 8.32% | 8.27% | 5.37% | 5.27% | 6.87% |
| Methylene chloride | 74.84% | 74.84% | 74.39% | 75.29% | 74.39% | 75.29% |
| n-butanol | 3.00% | 0.000% | 0.000% | 3.00% | 3.00% | 1.50% |
| TOTAL | 100.00% | 100.00% | 100.00% | 100.00% | 100.00% | 100.00% |
| Wt % in Film | | | | | | |
| VM114 | 89.07% | 89.07% | 86.51% | 91.80% | 86.51% | 91.80% |
| Citric acid | 0.00% | 2.97% | 0.00% | 0.00% | 0.00% | 0.00% |
| Drapex.6.8 | 2.97% | 0.00% | 5.77% | 0.00% | 5.77% | 0.00% |
| Triphenyl | 5.94% | 5.94% | 5.77% | 6.12% | 5.77% | 6.12% |
| Phosphate | | | | | | |
| Carboxymethyl | 2.02% | 2.02% | 1.96% | 2.08% | 1.96% | 2.08% |
| ethylphthalate | | | | | | |
| TOTAL | 100.00% | 100.00% | 100.00% | 100.00% | 100.00% | 100.00% |
| Film Properties | | | | | | |
| Break Strain (%) | 29.3 | 13.42 | 19.66 | 18.54 | 24.8 | 28.84 |
| Break Stress (psi) | 15,762 | 12,066 | 13368 | 13117 | 13229 | 15396 |
| Thickness, microns | 61.1 | 89.8 | 55.6 | 77.6 | 60.0 | 55.7 |
| Yield Strain (%) | 4.5 | 4.32 | 4.02 | 4.6 | 4.34 | 4.8 |
| Yield Stress (psi) | 11,246 | 11,660 | 11641 | 11675 | 10715 | 11159 |
| Young's Modulus | 467,353 | 459,754 | 459025 | 452609 | 411880 | 435193 |
| (psi) | | | | | | |
| Re @ 589 nm, | 0.0 | 0.1 | 0.3 | 0.1 | 0.2 | 0.1 |
| normalized to 60 | | | | | | |
| micron | | | | | | |
| Rth @ 589 nm, | −38.31 | −31.64 | −47.1 | −51.65 | −43.29 | −44.37 |
| normalized to 60 | | | | | | |
| micron | | | | | | |
| Haze (%) | 0.24 | 0.09 | 0.26 | 0.14 | 0.18 | 0.12 |
| Total Transmittance | 92.83 | 92.74 | 92.74 | 92.84 | 92.83 | 92.71 |
| (%) | | | | | | |
| Peeling Strength | 1 | 2 | 1 | 3 | 1 | 3 |
| Rating | | | | | | |

| | EXAMPLE | | | | | |
|---|---|---|---|---|---|---|
| | 19 | 20 | 21 | 22 | 23 | 24 |
| Wt % in Dope | | | | | | |
| VM114 | 15.00% | 15.00% | 15.00% | 15.00% | 15.00% | 15.00% |
| Citric acid | 0.50% | 0.00% | 0.25% | 0.00% | 0.00% | 0.15% |
| Drapex.6.8 | 1.00% | 0.50% | 1.00% | 1.00% | 0.00% | 1.00% |
| Triphenyl | 1.00% | 1.00% | 1.00% | 1.00% | 1.00% | 1.00% |
| Phosphate | | | | | | |
| Carboxymethyl | 0.34% | 0.34% | 0.34% | 0.34% | 0.34% | 0.34% |
| ethylphthalate | | | | | | |
| Methanol | 8.22% | 6.82% | 6.74% | 8.27% | 8.37% | 7.25% |
| Methylene chloride | 73.94% | 74.84% | 74.17% | 74.39% | 75.29% | 74.26% |
| n-butanol | 0.00% | 1.50% | 1.50% | 0.00% | 0.00% | 1.00% |
| TOTAL | 100.00% | 100.00% | 100.00% | 100.00% | 100.00% | 100.00% |
| Wt % in Film | | | | | | |
| VM114 | 84.08% | 89.07% | 85.28% | 86.51% | 91.80% | 85.76% |
| Citric acid | 2.80% | 0.00% | 1.42% | 0.00% | 0.00% | 0.86% |
| Drapex.6.8 | 5.61% | 2.97% | 5.69% | 5.77% | 0.00% | 5.72% |
| Triphenyl | 5.61% | 5.94% | 5.69% | 5.77% | 6.12% | 5.72% |
| Phosphate | | | | | | |
| Carboxymethyl | 1.91% | 2.02% | 1.93% | 1.96% | 2.08% | 1.94% |
| ethylphthalate | | | | | | |
| TOTAL | 100.00% | 100.00% | 100.00% | 100.00% | 100.00% | 100.00% |
| Film Properties | | | | | | |
| Break Strain (%) | 21.86 | 24.8 | 25.14 | 21.86 | 19.1 | 21.76 |
| Break Stress (psi) | 12710 | 14342 | 14167 | 13789 | 14130 | 14335 |
| Thickness | 91.1 | 81.5 | 83.8 | 62.0 | 86.5 | 61.0 |
| (microns) | | | | | | |
| Yield Strain (%) | 5.04 | 5.1 | 4.2 | 4.78 | 5.04 | 4.44 |
| Yield Stress (psi) | 10955 | 11431 | 11637 | 11488 | 12196 | 12276 |
| Young's Modulus | 391756 | 430277 | 435333 | 426376.5 | 442305 | 460021 |
| (psi) | | | | | | |
| Re @ 589 nm, | 0.1 | 0.4 | 0.2 | −0.1 | −0.2 | −0.1 |
| normalized to 60 | | | | | | |
| micron | | | | | | |
| Rth @ 589 nm, | −31.06 | −40.97 | −31.88 | −36.78 | −44.38 | −38.1 |
| normalized to 60 | | | | | | |
| micron | | | | | | |
| Haze (%) | 0.1 | 0.18 | 0.18 | 0.12 | 0.1 | 0.1 |
| Total Transmittance | 92.8 | 92.83 | 92.81 | 92.76 | 92.81 | 92.82 |
| (%) | | | | | | |
| Peeling Strength | 1 | 1 | 1 | 1 | 3 | 1 |
| Rating | | | | | | |

Examples 1-24 showed that there were no significant changes for planar retardation (Re), break strain, break stress, yield strain, Young's Modulus, haze, or total transmission, based on changes in the amount of the citric acid, ESO, and n-butanol. Yield stress showed slight decrease as the ESO level increased, and the thickness retardation (Rth) showed a decrease with increasing citric acid content.

### Examples 25-28

Three batches of dope were made and formed into films on a commercial pressure casting line. The batches of dope were prepared by adding a mixture of methylene chloride and methanol to a mixing vessel having a rotating stirrer. The VM114 and all other ingredients except citric acid were then added to the stirred vessel. Once a solution was obtained that was free of undissolved material, the citric acid was added to the solution. Stirring was continued for one hour. The film casting solution was then passed through filtration devices, and film was cast at the target thickness. The composition of the dopes and films, and the films' properties are reported in Table 3.

Peeling force in Table 3 was measured continuously by pressure transducers in the takeoff roll that peels the film from the casting belt.

Knurling pressure ratio in Table 3 is the ratio of force required to impart the knurling pattern of each experimental film to that typically seen for 100% lint-based CTA film.

TABLE 3

| | EXAMPLE | | | |
|---|---|---|---|---|
| | 25 | 26 | 27 | 28 |
| | Batch 1 | Batch 2 | Batch 3 | Batch 3 |
| Wt % in Dope | | | | |
| VM114 | 8.625% | 12.75% | 16.75% | |
| VM149 | 8.625% | 4.25% | 0.00% | |
| Citric acid | 0.057% | 0.056% | 0.055% | |
| Drapex. 6.8 | 0.57% | 0.56% | 0.56% | |
| Triphenyl Phosphate | 1.09% | 1.07% | 1.05% | |
| Carboxymethyl | 0.25% | 0.24% | 0.24% | |
| ethylphthalate | | | | |
| Tinuvin 328 | 0.08% | 0.08% | 0.08% | |
| Neo Heliopan 357 | 0.05% | 0.05% | 0.04% | |
| Methanol | 8.07% | 8.10% | 8.12% | |
| Methylene chloride | 72.59% | 72.85% | 73.10% | |
| TOTAL | 100.00% | 100.00% | 100.00% | |
| Wt % in Film | | | | |
| VM114 | 44.59% | 66.90% | 89.19% | |
| VM149 | 44.59% | 22.30% | 0.00% | |
| Citric acid | 0.29% | 0.30% | 0.30% | |
| Drapex. 6.8 | 2.97% | 2.96% | 2.96% | |
| Triphenyl Phosphate | 5.62% | 5.61% | 5.61% | |
| Carboxymethyl | 1.28% | 1.28% | 1.28% | |
| ethylphthalate | | | | |
| Tinuvin 328 | 0.42% | 0.42% | 0.42% | |
| Neo Heliopan 357 | 0.24% | 0.24% | 0.24% | |
| TOTAL | 100.00% | 100.00% | 100.00% | |
| Film Properties | | | | |
| Wt % of Sulfite | 50 | 75 | 100 | 100 |
| Softwood CTA | | | | |
| Wt % of Cotton | 50 | 25 | 0 | 0 |
| Lint CTA | | | | |
| Film Thickness (microns) | 60 | 60 | 60 | 40 |
| Transmission (%) | 93.2 | 93.3 | 93.3 | 93.2 |
| Haze (%) | 0.19 | 0.15 | 0.09 | 0.09 |
| b* color | 0.40 | 0.33 | 0.35 | 0.40 |
| Rth @ 589 nm | 36.45 | 37.63 | 40.50 | 31.30 |
| Peeling Force | 110 | 109 | 110 | 109 |
| from Casting Belt (N) | | | | |
| Knurling Pressure Ratio | 1.00 | 1.00 | 1.06 | 1.13 |

### Examples 29-34

Dopes and films were made following the procedures of Examples 1-24 with CTA derived from sulfite softwood, cotton lint, and hardwood having varying levels of sulfur to determine the peeling force required to separate the film from the casting substrate. These compositions were made to test the effect of sulfur on peeling force in the absence of the chelating agent and acid scavenger. The results indicate that the higher the sulfur level, the higher the peeling force.

The composition of the dopes and films, and the peeling force results are shown in Table 4.

TABLE 4

| | EXAMPLE | | | | | |
|---|---|---|---|---|---|---|
| | 29 | 30 | 31 | 32 | 33 | 34 |
| Wt % in Dope | | | | | | |
| VM114, sulfite softwood, | 13.65% | — | — | — | — | — |
| 11 ppm S | | | | | | |
| VM149, lint, 9 ppm S | — | 13.65% | — | — | — | — |
| PHK Hardwood CTA, 70 ppm S | — | — | 13.65% | — | — | — |
| Lint CTA, 37 ppm S | — | — | — | 13.65% | — | — |
| Lint CTA, 16 ppm S | — | — | — | — | 13.65% | — |
| Lint CTA, 25 ppm S | — | — | — | — | — | 13.65% |
| Triphenyl phosphate | 1.35% | 1.35% | 1.35% | 1.35% | 1.35% | 1.35% |
| Methylene chloride | 76.50% | 76.50% | 76.50% | 76.50% | 76.50% | 76.50% |
| Methanol | 8.50% | 8.50% | 8.50% | 8.50% | 8.50% | 8.50% |
| Wt % in Film | | | | | | |
| VM114, sulfite softwood, | 91.00% | — | — | — | — | — |
| 11 ppm S | | | | | | |
| VM149, lint, 9 ppm S | — | 91.00% | — | — | — | — |
| PHK Hardwood CTA, 70 ppm S | — | — | 91.00% | — | — | — |
| Lint CTA, 37 ppm S | — | — | — | 91.00% | — | — |
| Lint CTA, 16 ppm S | — | — | — | — | 91.00% | — |
| Lint CTA, 25 ppm S | — | — | — | — | — | 91.00% |
| Triphenyl phosphate | 9.00% | 9.00% | 9.00% | 9.00% | 9.00% | 9.00% |
| Sulfur in CTA (ppm) | 11 | 9 | 70 | 37 | 16 | 25 |
| Average Peeling Force (g) | 85 | 64 | 152 | 98 | 81 | 104 |

Samples of CTA having a range of sulfur content were made using sulfite softwood pulp as shown in Table 5. Above about 35 ppm sulfur content, increased peeling force from the casting substrate is observed when using the target amounts of additives.

TABLE 5

| % in Film | 1 | 2 | 3 | 4 |
|---|---|---|---|---|
| Sulfite Softwood 0.80% Xylose, | 89.82% | — | — | — |
| 0.97% Mannose (24.5 ppm S) | | | | |
| Sulfite Softwood 0.80% Xylose, | — | 89.82% | — | — |
| 0.97% Mannose (33.5 ppm S) | | | | |
| Sulfite Softwood 0.80% Xylose, | — | — | 89.82% | — |
| 0.97% Mannose (40.1 ppm S) | | | | |
| Sulfite Softwood 0.80% Xylose, | — | — | — | 89.82% |
| 0.97% Mannose (48.9 ppm S) | | | | |
| Citric acid | 0.15% | 0.15% | 0.15% | 0.15% |
| Drapex. 6.8 | 1.50% | 1.50% | 1.50% | 1.50% |
| Triphenyl Phosphate | 7.49% | 7.49% | 7.49% | 7.49% |
| Carboxymethyl ethylphthalate | 1.05% | 1.05% | 1.05% | 1.05% |
| Qualitative Peel Rating | 1 | 1.5 | 2 | 3 |

Additional sulfite softwood pulps having higher levels of the hemicelluloses impurities, xylan and mannan, were used to make CTA. Table 6 shows such pulps containing that up to 2% xylose and 1% mannose produce CTA having good peeling characteristics from casting belt substrate.

TABLE 6

| % in Film | 1 | 2 | 3 |
|---|---|---|---|
| Softwood Sulfite Pulp 0.80% Xylose, | 89.82% | — | — |
| 0.97% Mannose | | | |
| Softwood Sulfite Pulp 1.68% Xylose, | — | 89.82% | — |
| 1.10% Mannose | | | |
| Softwood Sulfite Pulp 1.94% Xylose, | — | — | 89.82% |
| 1.19% Mannose | | | |
| Citric acid | 0.15% | 0.15% | 0.15% |
| Drapex. 6.8 | 1.50% | 1.50% | 1.50% |
| Triphenyl Phosphate | 7.49% | 7.49% | 7.49% |
| Carboxymethyl ethylphthalate | 1.05% | 1.05% | 1.05% |
| Total | 100.00% | 100.00% | 100.00% |
| Qualitative Peel Rating | 1 | 1 | 1 |
| CIE b* Color | 0.184 | 0.215 | 0.263 |

Stability of optical properties is very important in LCD films. Durability testing was carried out for 1000 hours at 60° C. and 95% relative humidity on the films shown in Table 7.

TABLE 7

| % in Film | 1 | 2 | 3 | 4 | 5 |
|---|---|---|---|---|---|
| VM149 | 89.72% | 89.85% | — | — | — |
| VM114 | — | — | 89.72% | 89.85% | 89.99% |
| Citric acid | 0.30% | 0.15% | 0.30% | 0.15% | 0.00% |
| Drapex. 6.8 | 2.99% | 1.50% | 2.99% | 1.50% | 0.00% |
| Triphenyl Phosphate | 6.99% | 8.50% | 6.99% | 8.50% | 10.01% |
| CIE L* | | | | | |
| 0 Hours @ 60° C., 95% RH | 97.16 | 97.14 | 97.16 | 97.17 | 97.14 |
| 500 Hours @ 60° C., 95% RH | 97.08 | 97.13 | 97.13 | 97.14 | 97.14 |
| 1000 Hours @ 60° C., 95% RH | 97.06 | 97.08 | 97.12 | 97.14 | 97.11 |
| CIE a* | | | | | |
| 0 Hours @ 60° C., 95% RH | 0.000 | 0.000 | 0.000 | 0.000 | 0.000 |
| 500 Hours @ 60° C., 95% RH | 0.150 | 0.100 | 0.035 | 0.100 | 0.010 |
| 1000 Hours @ 60° C., 95% RH | 0.050 | 0.100 | 0.010 | 0.100 | 0.015 |
| CIE b* | | | | | |
| 0 Hours @ 60° C., 95% RH | 0.2 | 0.2 | 0.2 | 0.1 | 0.2 |
| 500 Hours @ 60° C., 95% RH | 0.3 | 0.2 | 0.2 | 0.2 | 0.2 |
| 1000 Hours @ 60° C., 95% RH | 0.3 | 0.2 | 0.2 | 0.2 | 0.1 |
| Haze | | | | | |
| 0 Hours @ 60° C., 95% RH | 0.31 | 0.49 | 0.30 | 0.26 | 0.39 |
| 500 Hours @ 60° C., 95% RH | 0.91 | 0.33 | 0.40 | 0.30 | 0.40 |
| 1000 Hours @ 60° C., 95% RH | 0.94 | 0.50 | 0.43 | 0.30 | 0.39 |
| Planar Retardation Of 60 | | | | | |
| micron films @ 589 nm | | | | | |
| 0 Hours @ 60° C., 95% RH | 0.47 | 0.05 | 1.42 | 0.74 | 1.59 |
| 500 Hours @ 60° C., 95% RH | 0.73 | 0.78 | 0.84 | 0.40 | 0.70 |
| 1000 Hours @ 60° C., 95% RH | 0.52 | 0.83 | 0.66 | 0.52 | 0.42 |
| Thickness Retardation Of 60 | | | | | |
| micron films @ 589 nm | | | | | |
| 0 Hours @ 60° C., 95% RH | −42.3 | −45.4 | −39.3 | −43.5 | −46.1 |
| 500 Hours @ 60° C., 95% RH | −38.5 | −42.7 | −39.6 | −39.8 | −44.5 |
| 1000 Hours @ 60° C., 95% RH | −38.5 | −44.3 | −41.9 | −45.7 | −44.7 |

The data shows the sulfite softwood CTA (VM114) to have very stable optical properties at the target levels of 1.5% acid scavenger and 0.15% citric acid. These stable optical properties are very important for use in LCD applications.

Belt deposits cause very tiny indentations in the film surface, which manifests itself as haze when the film is viewed at an angle. Such haze makes the films unacceptable, and the belt has to be cleaned. This down time reduces production and increases cost. In order to measure the effectiveness of the chelating agent in preventing deposits of salts on the film casting belt, an additional 30 day trial was made on the commercial film casting line using the target levels of 1.5% acid scavenger and 0.15% citric acid. No belt deposits occurred.

The invention has been described in detail with particular reference to preferred embodiments thereof, but it will be understood that variations and modifications can be effected within the spirit and scope of the invention.

We claim:

1. A dope for making a solvent-cast film comprising:
(a) cellulose triacetate made from sulfite-process softwood pulp and having less than 35 ppm of sulfur and less than 1 weight percent of xylose, both based on the weight of the cellulose triacetate, and a molar ratio of metals to sulfate of at least 3:1;
(b) an acid scavenger;
(c) a chelating agent; and
(d) a solvent.

2. The dope according to claim 1, wherein the cellulose triacetate has 8 to 15 ppm of sulfur.

3. The dope according to claim 1, wherein the cellulose triacetate has 0.5 to 0.6 weight percent of xylose.

4. The dope according to claim 1, wherein the cellulose triacetate comprises at least 98 weight percent of a-cellulose.

5. The dope according to claim 1, which comprises from 15 to 23 weight percent of the cellulose triacetate.

6. The dope according to claim 1, which comprises from 0.1 to 1 weight percent of the acid scavenger.

7. The dope according to claim 1, wherein the acid scavenger comprises epoxidized plant oil.

8. The dope according to claim 1, which comprises 0.01 to 0.1 weight percent of the chelating agent.

9. The dope according to claim 1, wherein the chelating agent comprises citric acid.

10. The dope according to claim 1, wherein the solvent comprises methylene chloride and from 6 to 20 weight percent of at least one of methanol and ethanol, based on the weight of the solvent.

11. The dope according to claim 1, for making a solvent-cast film comprising:
(a) having 8 to 15 ppm of sulfur, 0.8 weight percent or less of xylose, and at least 98 weight percent of a-cellulose, all based on the weight of the cellulose triacetate;
(b) the acid scavenger comprising epoxidized plant oil; and
(c) the chelating agent comprising citric acid.

12. A film comprising:
(a) cellulose triacetate made from sulfite-process softwood pulp and having less than 35 ppm of sulfur and less than 1 weight percent of xylose, both based on the weight of the cellulose triacetate, and a molar ratio of metals to sulfate of at least 3:1;
(b) an acid scavenger; and
(c) a chelating agent.

13. The film according to claim 12 comprising:
(a) having 8 to 15 ppm of sulfur, 0.8 weight percent or less of xylose, and at least 98 weight percent of a-cellulose, all based on the weight of the cellulose triacetate;
(b) the acid scavenger comprising epoxidized plant oil; and
(c) the chelating agent comprising citric acid.

14. The film according to claim 13, which has a thickness of 20 to 100 microns.

15. The film according to claim 13, which comprises from 1 to 5 weight percent of the acid scavenger.

16. The film according to claim 13, which comprises 0.1 to 0.5 weight percent of the chelating agent.

17. The film according to claim 13, which comprises from 80 to 95 weight percent of the cellulose triacetate.

18. A method of preparing the dope according to claim 1, which comprises:
(a) combining the cellulose triacetate, the acid scavenger, and the solvent together to form a solution; and
(b) adding the chelating agent to the solution from step (a) to form the dope.

19. A method of preparing the dope according to claim 11, which comprises:
(a) combining the cellulose triacetate, the acid scavenger, and the solvent together to form a solution; and
(b) adding the chelating agent to the solution from step (a) to form the dope.

20. A method of making a film comprising:
(a) casting the dope according to claim 1 onto a continuously moving support to form a cast film on the support;
(b) partially drying the cast film;
(c) separating the cast film from the support; and
(d) drying the separated film.

21. A method of making a film comprising:
(a) casting the dope according to claim 11 onto a continuously moving support to form a cast film on the support;
(b) partially drying the cast film;
(c) separating the cast film from the support; and
(d) drying the separated film.

22. A polarizer plate for a liquid crystal display comprising the film according to claim 12.

23. A polarizer plate for a liquid crystal display comprising the film according to claim 13.

24. An optical lens comprising the film according to claim 12.

25. An optical lens comprising the film according to claim 13.
